(19) United States
(12) Patent Application Publication
(10) Pub. No.: US 2017/0263107 A1
(43) Pub. Date: Sep. 14, 2017

(54) Approaching Proximity Warning System, Apparatus and Method

(71) Applicants: Derek Thomas Doyle, Albuquerque, NM (US); Breanna April Cleghorn, Albuquerque, NM (US)

(72) Inventors: Derek Thomas Doyle, Albuquerque, NM (US); Breanna April Cleghorn, Albuquerque, NM (US)

(21) Appl. No.: 15/066,752

(22) Filed: Mar. 10, 2016

(51) Int. Cl. G08B 25/01

(52) U.S. Cl. CPC G08B 25/016

(57) ABSTRACT

A wearable approaching proximity warning system monitoring device invention is described that detects approaching objects and alerts the user by mechanical/optical/audible means. Additional monitoring may be established for tracking high impact shocks. Settings may include adjustable thresholds for alarms and tracking/transmitting events via Internet/text message to emergency contacts.

### CROSS-REFERENCE TO RELATED APPLICATIONS

This application is an improvement and alternative embodiment of concepts related in part to U.S. Pat. Nos. 6,731,202; 8,884,809; 20160037137; U.S. Pat. No. 9,224,227; and 20150332563.

### STATEMENT REGARDING FEDERALLY SPONSORED R&D

No Federal sponsored rights are applicable to the invention.

### NAMES OF PARTIES TO A JOINT RESEARCH AGREEMENT

This work is not subject to a joint research agreement.

### BACKGROUND OF THE INVENTION

1. Field of the Invention

The present invention relates to an approaching proximity warning system which is embodied as a personal device apparatus able to be worn and utilizes certain methods for measuring and reporting details for targets only approaching the system within the designed sensing field of view. The device is able to be used without peripherals but is able to interface with the user's personal electronic device and a chosen stimulus response device such that the user's traditional data link between the personal electronic device and stimulus device may be interrupted by the approaching proximity warning system to alert the user of an approaching object. The invention is intended to provide increased situational awareness to the user in their surrounding and further provide warning in cases of high risk approaching objects.

2. Description of the Prior Art

U.S. Pat. No. 6,731,202 describes a cycle-mounted vehicle proximity warning device warns a cyclist that a vehicle is approaching the cycle from the rear. A like device, worn by a pedestrian, warns the pedestrian of approaching vehicles. The warning device includes a vehicle detector circuit and an antenna that transmits and receives. The vehicle detector circuit detects a vehicle as it approaches the cycle or pedestrian and emits a detection signal. An alarm circuit responds to the detection signal and communicates an audible, visual, or tactile warning to the cyclist or pedestrian. The vehicle proximity warning device also includes a vehicle alert circuit that can activate a bright flashing light aimed at the approaching vehicle for the purpose of alerting its driver of the cyclist or pedestrian proximity.

This previous technology includes an external alert circuit in all independent claims intended for alerting the driver of the user's location. Its alternate purpose is to get the user's attention of an approaching car for their awareness. This previous invention is designed with ranges, radar cross sections and speed thresholds relevant to moving vehicles and does not have the sensitivities required to focus on rear approaching pedestrians, animals, and cyclists. The scope of the technology is limited to detection of vehicles and further interacts with the approaching vehicle to solicit awareness to the external party. It does not permit interruption of established data links for a user as the included invention herein does. Further, the present invention requires no circuitry for interacting with the approaching object.

U.S. Pat. No. 8,884,809 describes a personal electronic device that is configured to provide enhanced user awareness of the environment responsive to data from a micro-impulse radar (MIR).

The utility of the described technology incorporates micro impulse radar to characterize various attributes of the environment and is designed for detailed measurements in a range of 10 s of feet max. Like most radar systems, this requires a level of sophistication wherein the source waveform and receiver components are able to generate and receive pulsed waveforms so as to assess the various features associated with scattered rf waves to attribute the features to changes in the environment. The referenced invention utilizes technologies and methods intended for very specific details about the objects in the sensing range with level of detail down to the beating heart patterns multiple bodies. The scope of the referenced invention is greatly more complicated than a basic warning system as is described herein where basic awareness is provided to the user by alerting them of only relevant objects that may intercept their path. Further the referenced patent is not intended for use or with the same operational modes as the invention described herein.

U.S Patent Application 20160037137 filed Feb. 4, 2016 describes a system which includes a head mounted, wearable device with at least one sensory output device for conveying information about the surrounding environment to a user and at least one enhancement device coupled to the wearable device. The enhancement device includes at least one imaging device configured to receive real-time images, and a feedback system configured to process the real-time images to obtain the information about the surrounding environment and to transmit the information to the sensory output device.

This device is intended for enhancing the visual capabilities of users with possible loss of vision. It is limited to improving the user's field of view with respect to visual awareness.

U.S. Pat. No. 9,224,277 describes techniques that can relate to a multi-purpose detector surface on a network device. A stimulus variable can be identified at a detector device based on an environmental stimulus detected by a sensor. The detector device can include the sensor. The detector device can transmit an initial communication to a device. The first communication can include the stimulus variable. A new communication that includes data corresponding to another device can be received at the detector device. The detector device can determine, based on the stimulus detected by the sensor and is further based on the new communication, that a visual stimulus is to be presented. The visual stimulus can be presented.

This invention limits the scope of the process of interfacing a sensor measurement to a user in the form of visual cues. With the multitude of portable devices that exist there are alternatives to this process to additionally incorporate the ability to define the interface to include audio feedback over headphones, dynamic response via a smartphone or smartwatch, audible tones or dynamic vibration from the sensing system directly.

U.S Patent Application 20150332563 filed Nov. 19, 2015 describes a wearable pedestrian safety radar system including a harness with a pocket and a portable radar speed detection and display device to be worn on the front and back of the harness by a pedestrian while on a roadway. The device includes a radar system, LED lights, a microcontroller, a proximity sensor, a camera, a strobe light, an audible alert unit and a vibration unit. The device detects a speed of an on-coming motor vehicle. If the vehicle is exceeding a predetermined speed limit, the speed is displayed on the device. If the vehicle does not slow down below the speed limit within a distance detected by the proximity sensor, the camera records the vehicle while the strobe light blinks to warn the driver of the recording. The audible alert unit and vibration unit alert the pedestrian. The system may be used to relay data to a law enforcement agency.

This invention is designed for use with a harness with multiple mounting pockets and a display device for showing speed and is limited to vehicular utility and is intended for providing information to the user and driver for speeding infraction purposes. It further requires input from the user for allowable speed and is intended to be used in connection with law enforcement.

While various methods of proximity detection have been developed through multiple acoustic to electro-magnetic implementations, these devices have neglected to properly focus on simplifying the scope for a personal system that alerts the user of objects approaching their defined blind spot. Radar systems usually require increasingly complex controls to isolate targets, define distances and distinguish real objects from environmental clutter. The vehicular industry has also been developing multiple concepts that rely on signal processing techniques to define threat assessment and influence vehicle responses such as U.S. Pat. No. 8,232,872. But these systems are not embodied in a personal portable device and are created for influencing the actions of the car. Ultimately, for an individual standing or traversing along a given path, the minimal information required to provide awareness of their proximity is of the presence of an approaching object(s) that they cannot readily see in their field of view. The Doppler shift allows for approaching objects to be distinguished from departing objects by due to the increase in carrier frequency of the interrogation method used to identify objects. Considering no known product to achieve this goal can be found on the market identifies the lack of these units existing for the intended use of this patent. Such a system would increase the safety and awareness for the user in times where awareness may be hindered or help may not be nearby.

### SUMMARY OF THE INVENTION

The present invention is an approaching proximity warning system which is intended to be located on a user's desired blind side, such as their rear, where it may be affixed to the back via an accessory pocket or latch that may be affixed to clothing or belt, or to a mounting unit that may be attached to a user's helmet or chosen mobile transport system. The system would be battery powered and interface to multiple devices where the intended control interface would be in the category of a smartphone and the feedback device may be a connected headphone set. The system would interface the chosen devices to create a data bridge such that the device(s) would operate as the user chose until the system detects an approaching object. At such time the system would interrupt the normal operation of the device(s) to provide warning stimuli. The best mode perceived at the time of this submission is an interface between a smartphone and audio headset where an audio interrupt in the form of beeping would alert the user that there is an approaching object behind them. It is additionally foreseen that such a warning system may be enhanced with an acceleration measurement component and possibly a Short Message Service (SMS) enabled module, such as a GSM component, to alert an emergency contact of any high shock events that may occur in the instance of a collision of the approaching object that influence the trajectory of the user.

It is therefore a primary object of the present invention to provide approaching proximity alerts to the user of the system.

It is further an object of the invention to be able to adjust the sensitivity of the sensors detection thresholds of approaching object(s).

It is further an object of the invention that the device be wearable on the individual either by a latched mounting method or compact size to fit into an accessory/clothing pocket.

It is another object of the invention that the device interfaces with a user's personal electronic device such as a phone/tablet/computer to provide a control interface for adjusting settings.

It is yet a further objective of the invention that the device would pair with an alert system such as headphones/visual display/smartwatch/smartphone to provide a mechanical, audible, or optical warning of a threshold detecting event.

It is another primary object of the invention that any sudden change in user's mobility be monitored by the system.

It is another objective that the events of proximity or shock may be logged and transmitted to desired contact using an integrated SMS enabled module or the users own personal electronic device such as a smartphone.

It is expected that these and other objects of the present invention, will become apparent to those skilled in this art upon reading the accompanying description, drawings, and claims set forth herein. The heading provided herein is for the reader's use only and should not be considered to be limiting upon the content in any way.

### BRIEF DESCRIPTION OF THE DRAWINGS

FIG. 1 shows one possible approximate location on a user's back with a breakout of the system to show the functional components of the system.

FIG. 2 shows a basic geometric visualization of the system.

FIG. 3 shows the basic operational function diagram intended to be implemented in the system when under use.

### DETAILED DESCRIPTION OF THE INVENTION

1. Definitions

Short Range Radar as used herein shall mean a means by which a transceiver sends and receives electromagnetic waves (RF, milimeter, IR, visual, etc.) through space to reflect off moving and static objects and where the reflected waveforms are received by the same unit with a range of interest less than 100 m for the purpose of scoping “short range”. The transceiver may be composed of one or more antenna elements and waves are broadly used to capture the full spectrum of frequencies applicable to Doppler type measurements and wave types from continuous to pulses, and with/without modulation necessary to distinguish features relevant to identifying and classifying targets. Of specific interest to this invention is the isolation and classification of features corresponding with an approaching object with respect to geospatial position of the system described herein.

Piconets as used herein shall mean a wirelessly connected group of devices utilizing wireless, typically Bluetooth, protocols in a localized area creating a “pico” network. Multiple pico networks may be supported by a single wireless module if it supports scatternet protocols such that the invention may act as a master in one mode and slave in another mode.

2. Best mode of the Invention

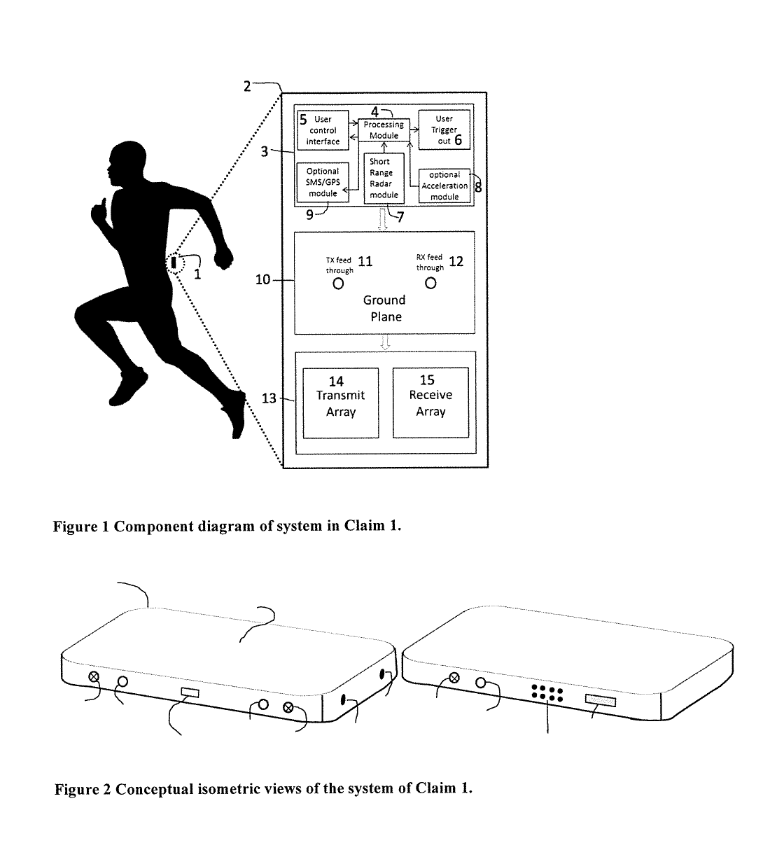

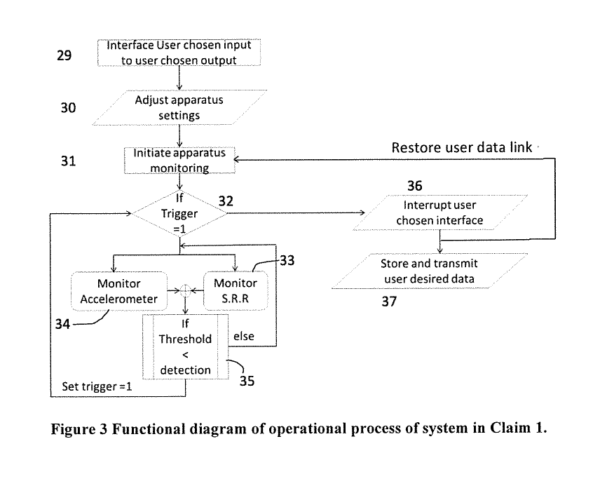

Three figures are used to describe the system, apparatus and basic operational method of the invention. FIG. 1 provides a breakout of the likely best mode for required system components to support the invention claims, where each component should be fundamentally understood for its purpose/function to those experienced in electrical engineering. An additional indication of approximate intended placement on a user is shown. However, such a module may be affixed to multiple locations on a user or to different mounting locations on a chosen host structure by the user. FIG. 2 shows two isometric views of the best mode contemplated by the inventor of the approaching proximity warning apparatus 16 according to the concepts of the present invention. The invention is configured to allow multiple modes of operation based on the user's needs. The simplest method is to operate the device without any peripheral devices and rely on an audible alarm or mechanical vibration as the alert method. From there the next level mode would be to pair the invention with either an output device, such as headphones, where optionally, internal audio storage can play a preloaded music playlist and be interrupted as required by scanning operation. Similarly the device may solely be paired with the interface device, such as a smart phone, and trigger alerts through mechanical or audible means. Further stimulus devices are always emerging in the field, such as video enabled headset, where an alert message or indication may be fed to optical alert type system. The most capable method, and expected most common, is to pair the interface device directly to an output device to establish the most flexible data link possible and work with both devices together. FIG. 3 provides the fundamental process of operation of the invention in a flow diagram where operational mode and settings are established, scanning is initiated by the user as a while loop, and any identification of approaching objects are reported to the user through the user defined preferences.

3. How to Make the Invention

As can be amply seen from FIG. 1 and FIG. 2 of the drawings, the approaching proximity warning system 16 is a small electronic device intended to be worn on the individual. It is expected that the most likely location is affixed to the user's lower back 1 where the unit can stored in a pocket of a clothing belt or accessory. Additionally the unit can be designed with an indented grooved slot on the back and locking wedges on the bottom to attach to a separate tab inserting latch mechanism that can be coupled with a user desired mounting location such as a strap latch, helmet, or wherever a latch may be affixed by the user.

The components comprising the system 1 are collectively shown in FIG. 1 represented by a consolidated box 2 consisting of three separate layers. The electronics layer 3 houses all electrical control components and is shown to be simplified to its principal operational parts. The system is controlled with a processing module 4, such as a microcontroller, that handles the various data input and output interfaces and performs calculations required for characterizing an approaching object such as an approaching velocity vector rather than a departing velocity vector as defined by Doppler shift, or more detailed through object distance tracking for determining trajectory and assessing if it is approaching or departing. The processing module 4 interfaces with a user control interface 5, such as a smartphone, tablet, or PC. This interface is used for adjusting controls and warning thresholds and for linking stimuli devices to the control interface. Interface with the user device can be achieved through a wired means, such as a micro USB connector or a wireless Bluetooth module. The linking stimuli device is interface to the system via the user trigger out module 6. This invention may be interfaced wired or wirelessly using Bluetooth or other appropriate data interface protocols to stimulus peripherals that can provide mechanical, optical, or audio warnings such as a tone over a headset. Since the invention operates in a mode where it may be communicating with two Bluetooth devices at the same time it is possible that a variety of piconet topologies may be possible to accommodate the various modes. It is perceived that the best solution will be a trade between cost and data bandwidth between achieving two data connections with a single Bluetooth master module that supports scatternet (supports multiple piconet relations) or just using two separate Bluetooth modules to accommodate the mixed master/slave setups between the various device setups. Given industry components and maturation rate of Bluetooth, it is expected that the best mode of the invention may soon support a single module, but for now two separate units are needed to treat the output as a slave and the input as a master. It is not recommended that the input device connect to both the intended output device and this invention as two slaves as the data transmission rates may hinder the sensing range and response time.

Additional sensing capability can also be applied for additional safety concerns. While it is captured in FIG. 1, it is not required to support the principle function of the device but rather adds function. One approach is achieved by an optional acceleration module 8 which monitors for sudden abrupt shocks to the user through either an accelerometer or inertial measurement unit. For the purposes of monitoring shock, a signal conditioned triaxial shock accelerometer may be utilized wherein the z axis is configured to align with the normal vector of the ground and an example magnitude of more than 10 Gs may be used in the X and Y axis data input pins to the microcontroller 4 to sense a sudden fall to the user on their front, back, or side. As many processing modules can support multiple data input pins, it is possible to accommodate an assortment of additional measurements beyond the scope of shock that enable situational awareness of the user's status and that can be used as reportable event trackers.

Finally an optional SMS enabled module 9 is included in the system to provide alert transmissions to a defined emergency contact as set by the user in the initial setup. The SMS module may also be paired with a Global positioning system (GPS) receiver to capture location data in the outbound SMS text alert. While this service is ideally enabled through the interface to the user input device if it is a device such as a smartphone, it is foreseeable that some users may not prefer to operate in that specific mode and thus an optional addition is foreseen to accommodate the optional function of reporting to emergency contacts. SMS enabled modules exist for GSM/GPRS, UMTS/HSDPA and CDMA modems. Market requirements and region of sales may influence modem selection. It is expected that GSM/GPRS modems will be the most likely used within the system.

Atop the electronic layer 3 is a ground plane 10 which is used to both increase directivity of the short range radar antenna 14 and 15 but also isolate the electronics layer from external noise. The conductive ground plane requires a transmission line feed through to interface the electronics layer 3 to the antenna layer 13. The TX (transmit) feedthrough 11 and RX (receive) feedthrough 12 may be combined into one if a single antenna is used for transmitting and receiving or broken into additional feedthroughs if multiple arrays are required to transmit or receive from the user's unseen field of view. The antenna layer 13 is the top functional layer of the assembly and houses the antenna construct. It is perceived by the inventor that two separate patch antenna arrays are the best method of utilizing the invention but multiple implementations are possible depending on the regulated frequency spectrum, required user sensing range, sensitivity and field of view and multiple system models can be designed to accommodate the range of needs.

The housing embodying the system 2 affixed to the user 1 is illustrated in FIG. 2. The system is simplified in the illustration to show the minimum features required for use. The unit would consist of an orientation indication graphic 17 that would allow the user to perceive the correct orientation of the device for use. A syncing button would be used for the input device 18 and the output device 19 where LED lights 20 and 21 can provide status information to the user about the sync state. Additionally two wired jacks may be used instead for input audio 22 and output audio 23 where output audio 23 may provide signal for other stimulus accessories beyond audio based. The device would use a traditional miniature interface port 24, such as micro-USB for charging the battery or interfacing to a PC or other user interface device to support file uploads and setting adjustments. On the top side of the system may be a power button 25 and system mode LED 26 to allow the user a basic indication of the state the system is in. Finally a volume switch 27 is expected to be use to adjust the signal strength of the input to output device with respect to an interrupt warning such that the linked data may be completely isolated or overlapped with the warning signal. Not shown is a traditional latching option that would be on the side opposite of the orientation indication graphic 17 that would likely include a grooved slot with wedges on both sides of the power/data interface port 24 to accommodate a latching mechanism consisting of an inserting tab loaded lever to overlap the wedges. Additionally it should be noted that the case should be made with best engineering practices for rounding edges and corners to reduce shock loads that may hinder functionality of sensitive electronic interconnects. Additional needs include a top face (hosting the orientation indication graphic 17) that is made with an appropriate RF radome material to minimize electromagnetic losses for achieving the highest level or performance.

4. How to Use the Invention

To operate the device, the user would first power on the system using the power button 25 and ensure proper status by the indication LED 26. The user would then interface their chosen input and output devices via wired ports 22 and 23 or wireless means via the input and output sync buttons 18 and 19 while checking for established connections via the associated status LEDs 19 and 20. Scanning can be initiated by tapping the power button 25 once again and the system would then be placed on the rear of the user 1 with the orientation image 17 showing outward for proper placement. The expected common connection for this invention is expected to be linking a smartphone to headphones where music or phone calls are passed through. This connection allows data to pass from the user control interface 5 to the user trigger out module 6 uninterrupted during operation omitting the presence of a threshold exceeding trigger event. However, it is additionally feasible that the invention may work only with one of the two devices or on its own by attaching a mechanical/optical/audible alert device such as a buzzer 28 to the control processor 4. If the user wanted to utilize the invention on its own or with just an output device such as headphones, they may utilize the interface connection to upload a playlist to the control processor to provide limited audio playback that can be used while the sensor is being operated and that may be interrupted as needed for warning. While the system is being used as a sensor, the short rang radar module 7 will operate with the processing module 4 to identify targets that register as an approaching object. Anyone skilled in the art of radar or Doppler understands that there are multiple methods to distinguishing an approaching object ranging in complexity from observing a return frequency that is higher than the transmitted frequency to identifying ranges and comparing between cycled measurements to calculate a rate in change of distance. Approaching objects with features that exceed the thresholds defined by the user settings will initiate an interrupt in the processing module 4 that will bypass data from the user control interface 5, such as audio playback, and feed in a warning alert to the user trigger out 6. The features of this warning may correspond to the approaching objects signal strength and speed in the form of increased amplitude and frequency of the alert to the user. Once the triggering event stops exceeding threshold levels, the alert will stop and the original data interface will be restored. Additionally the unit can monitor the acceleration module for impacts associated with falls and send that alert to the processing module where the warning data can be sent back to the interface device, such as a smartphone, or through an additional SMS enabled module to transmit data of the event (time, type of event, location via GPS, etc.) to an emergency contact.

FIG. 3 shows the basic operational flow diagram for the unit under operation. The user establishes a chosen interface chain first 28 and then adjust setting as needed 29. Once they initiate monitoring 30, a logic loop or while loop is basically established where the defined interface is left alone and the trigger is set to ‘0’ until a threshold is exceeded 31. The threshold may come from the short range radar (S.R.R) 32 or the acceleration module 33 which represents the additional sensing capability for user status monitoring. Once a detected signal exceeds a threshold 34, the trigger is set to 1 and the loop is temporarily broken 31 to allow the interrupt to occur 35 after the interrupt the data may be stored and transmitted per the user's settings 36 and then the user link is restored setting the trigger back to ‘0’. If a threshold exceeding event is still present the loop will continue to be interrupted until the threshold exceeding event ceases.

Thus it will be appreciated by those skilled in the art that the present invention is not restricted to the particular preferred embodiments described with reference to the drawings, and that variations may be made therein without departing from the scope of the present invention as defined in the appended claims and equivalents thereof.

1. An approaching proximity warning system, comprising: a means of detecting approaching objects; a means for transmitting and receiving electromagnetic waves to the users chosen unseen field of view; a means of reporting the presence of an approaching object; and a means of processing input and output data.

2. The approaching proximity warning system according to claim 1, wherein a means to route data only to and/or from a chosen user interface device during scanning operation; and wherein the warning is provided in the form of an audible sound, an optical image, or mechanical vibration response from the user interface device.

3. The approaching proximity warning system according to claim 1, wherein a means of interface to a user stimuli output device during scanning operation is available; and wherein the warning is provided in the form of an audible sound, an optical image, or mechanical vibration response from the output device.

4. The approaching proximity warning system according to claim 1, wherein a means for the system to be configured with an audio playback capability to transmit digitally stored audio on the system to an audio playback device via the output stimuli device; and wherein the alert signal would interrupt the audio playback during scanning operation.

5. The approaching proximity warning system according to claim 1, wherein said system can be configured with additional sensing components to serve as threshold monitoring events within the defined system enclosure and interfaced to the processing module to serve as added alert input sources.

6. The approaching proximity warning system according to claim 1, wherein said system can be configured with additional transmitting modules for outgoing messages.

7. An approaching proximity warning apparatus comprising: a microcontroller for processing measurements for features indicating an approaching object; a short range radar module capable of generating electromagnetic waves, transmitting and receiving electromagnetic waves; and a mechanical, optical, or audible alarm.

8. The approaching proximity warning apparatus according to claim 7 wherein a wireless or wired connection means is used to interface the apparatus with a user interface device that is configured with a means for providing stimuli response.

9. The approaching proximity warning apparatus according to claim 7 wherein a second wireless or wired connection means is used to interface the apparatus with an alert-capable stimuli device.

10. The approaching proximity warning apparatus according to claim 7 wherein a means of interfacing stored digital memory either by integrated chipsets or removable media is used to support audio playback to an output stimuli device intended for audio data.

11. The approaching proximity warning apparatus according to claim 7, wherein a ground plane is used to isolate the electronics from its operational antenna and to provide improved directivity of the antenna beam shape.

12. The approaching proximity warning apparatus according to claim 7, wherein said system can be configured with a GPS module for tracking and correlating location data with respect to alert events when commanded.

13. The approaching proximity warning apparatus according to claim 7, wherein said system can be configured with a GPRS/GSM module for reporting details of alert events to a user defined contact number.

14. The approaching proximity warning apparatus according to claim 7, embodied in a hermetically sealed enclosure comprising: no sharp edges and shock absorbing design; a power button and accompanying system operational status LED; an interface port for power and data interface; a set of sync buttons and accompanying status indicating LEDs; a set of interface jacks for input and output audio; a mounting bracket on the backside of the case; an orientation graphic on the front to aid in indicating orientation; and an analog dial to define the ratio of warning to standard data interface amplitude.

15. An approaching proximity warning method wherein an alert response of a desired magnitude and duration is provided based on the measured features of an approaching object.

16. The approaching proximity warning method according to claim 15 wherein the alert may pause a currently streaming data connection.

17. The approaching proximity warning method according to claim 15, wherein an alert may disrupt the chosen data link by some adjustable alert signal-to-standard operation signal ratio so as to vary the alert response with respect to the datalink such that the alert may overlay the data link so that the original data link is maintained or completely isolate the alert signal from the data link feedback so that only the alert signal is transmitted to the user's chosen output stimuli device.

18. The approaching proximity warning method according to claim 15, wherein said method includes a means of altering the settings of measured feature for defining threshold levels.

19. The approaching proximity warning method according to claim 15, wherein said method includes a means of altering the output format of the reportable alert based on user desired level of detail.

20. The approaching proximity warning method according to claim 15, wherein a means of associating approaching objects to likely types of objects based on the received signal strength and determined speed are reported in the user chosen alert format.
